(19) United States
(12) Patent Application Publication
(10) Pub. No.: US 2026/0194027 A1
(43) Pub. Date: Jul. 9, 2026

(54) A PISTON HEAD FOR COMBUSTION CYLINDER, AND A COOLING GALLERY FOR A PISTON HEAD OF A COMBUSTION CYLINDER

(71) Applicant: Cummins Inc., Columbus, IN (US)

(72) Inventors: Ashutosh Shriniwas Chaware, Pune (IN); Sumit Sanjay Vispute, Pune (IN); Siba Padhy, Pune (IN); Nitin M. Banugade, Pune (IN); Tusher Vishwasrao Takawale, Pune (IN); Anand Ashok Sonawane, Pune (IN)

(73) Assignee: Cummins Inc., Columbus, IN (US)

(21) Appl. No.: 19/130,085

(22) PCT Filed: Nov. 16, 2023
(86) PCT No.: PCT/US2023/080036

§ 371 Date: May 14, 2025

(30) Foreign Application Priority Data
Nov. 18, 2022 (IN) 202241066203

(51) Int. Cl. F02F 3/22; F02F 3/00

(52) U.S. Cl. CPC F02F 3/22; F02F 3/003; F02F 2003/0061

(57) ABSTRACT

A piston head includes a piston head lower portion and a piston head upper portion coupled to the piston head lower portion. The piston head upper portion includes an end wall, an outer wall, and an inner wall. The end wall includes, an outer portion and an inner portion, angled with respect to the outer portion. The outer wall extends axially away from the end wall in a first direction. The inner wall extends axially away from the end wall in the first direction and is separated from the outer wall such that an outer chamber is defined between the outer wall and the inner wall and an inner chamber is defined within the inner wall. The inner wall defines one or more openings fluidly connecting the inner chamber to the outer chamber. An axis of each of the one or more openings is substantially parallel to the inner portion.

### CROSS-REFERENCE TO RELATED APPLICATION

This is a PCT Application claims the benefit of Indian Provisional Patent Application No. 202241066203, filed on Nov. 18, 2022, entitled PISTON FOR COMBUSTION CYLINDER, the contents of which is incorporated herein by reference in its entirety. The present application generally relates to a piston for use in a combustion cylinder.

### FIELD

The present application generally relates to a piston for use in a combustion cylinder.

### BACKGROUND

Internal combustion engines generally combust a mixture of fuel (e.g., diesel, gasoline, natural gas, etc.) and air within a combustion chamber. The combustion of the air-fuel mixture causes a piston to move, which in turn generates power (e.g., for moving a vehicle, powering equipment, etc.). The combustion of the air-fuel mixture also increases the temperature of the piston. A fluid such as oil may be provided at the piston to dissipate the heat generated by the combustion thereby cooling the piston.

### SUMMARY

Various embodiments provide for a piston for a combustion cylinder. The piston includes a piston head having a piston head lower portion and a piston head upper portion coupled to the piston head lower portion. The piston head upper portion includes an end wall, an outer wall, and an inner wall. The end wall includes an outer portion and an inner portion, angled with respect to the outer portion. The outer wall extends axially away from the end wall in a first direction. The inner wall extends axially away from the end wall in the first direction and is separated from the outer wall such that an outer chamber is defined between the outer wall and the inner wall and an inner chamber is defined within the inner wall. The inner wall defines one or more openings fluidly connecting the inner chamber to the outer chamber. An axis of each of the one or more openings is substantially parallel to the inner portion.

Various other embodiments provide for a piston head. The piston head includes a piston head lower portion and a piston head upper portion coupled to the piston head lower portion. The piston head upper portion includes an end wall, an outer wall, and an inner wall. The end wall includes an outer portion and an inner portion, angled with respect to the outer portion. The outer wall extends axially away from the end wall in a first direction. The inner wall extends axially away from the end wall in the first direction and is separated from the outer wall such that an outer chamber is defined between the outer wall and the inner wall and an inner chamber is defined within the inner wall. The inner wall defines one or more openings fluidly connecting the inner chamber to the outer chamber. An axis of each of the one or more openings is substantially parallel to the inner portion.

Various other embodiments provide for a cooling gallery for a piston head of a combustion cylinder. The cooling gallery includes an end wall including an outer portion and an inner portion, angled with respect to the outer portion. The cooling gallery also includes an outer wall and an inner wall. The outer wall extends axially away from the end wall in a first direction. The inner wall extends axially away from the end wall in the first direction and is separated from the outer wall such that an outer chamber is defined between the outer wall and the inner wall and an inner chamber is defined within the inner wall. The inner wall defines one or more openings fluidly connecting the inner chamber to the outer chamber. An axis of each of the one or more openings is substantially parallel to the inner portion.

These and other features, together with the organization and manner of operation thereof, will become apparent from the following detailed description when taken in conjunction with the accompanying drawings, wherein like elements have like numerals throughout the several drawings described below.

### BRIEF DESCRIPTION OF THE FIGURES

FIG. 1 is a cross-sectional view of a combustion chamber assembly, according to an example embodiment.

FIG. 2 is another cross-sectional view of the combustion chamber assembly of FIG. 1.

FIG. 3 is a perspective view of a piston head usable in the combustion chamber assembly of FIG. 1, according to an example embodiment.

FIG. 4 is a side cross-sectional view of the piston head of FIG. 3.

FIG. 5 is another side cross-sectional view of the piston head of FIG. 3.

FIG. 6 is yet another side cross-sectional view of the piston head of FIG. 3.

FIG. 7 is a top cross-sectional view of the piston head of FIG. 3.

FIG. 8 is a perspective view of the piston head of FIG. 3 shown with a drain plug, according to an example embodiment.

FIG. 9 is a perspective view of the drain plug of FIG. 8.

FIG. 10 is a perspective view of the piston head of FIG. 3 shown with a drain plug, according to an example embodiment.

FIG. 11 is a perspective view of the drain plug of FIG. 10.

FIG. 12 is a perspective view of the piston head of FIG. 3 shown without a drain plug.

### DETAILED DESCRIPTION

Embodiments described herein relate generally to a piston head for a combustion chamber assembly. According to various embodiments, the combustion chamber assembly includes a piston head configured to enable heat transfer from the piston head to a fluid, such as oil. The piston head may advantageously improve the heat transfer by providing an increased surface area for the fluid to contact the piston head.

Before turning to the figures, various embodiments of the combustion chamber assembly and components thereof are described herein. It should be understood that, while individual components are described in detail, the details should be considered as examples only. Further, the details may include variations described herein. Accordingly, it should be understood that, although individual components may be described relative to an embodiment, any of the components may be used in any other embodiment described herein, unless otherwise noted.

The embodiments of the pistons described herein are used in an internal combustion engine are exposed to high temperatures during operation. To moderate the temperature, the pistons may include a cooling gallery. A fluid is sprayed into the cooling gallery as the piston reciprocates along a cylinder bore of the engine. The fluid flows along the inner surface of the piston and dissipates heat away from same. Advantageously, embodiments described herein consistently provide an adequate flow of fluid to control (e.g., decrease) the piston temperature during operation. The decreased piston temperature may advantageously mitigate fluid degradation caused by the high temperature of the internal combustion engine. Furthermore, the decreased piston temperature may mitigate had carbon build-up in the surface of the cooling gallery caused by high piston temperatures (e.g., piston temperatures greater than 330° C.).

Embodiments described herein relate to a piston head for a combustion chamber assembly that advantageously improves heat transfer from combustion chamber to a fluid such that the operating temperatures of the piston is reduced. The reduced operating temperature may improve engine brake thermal efficiency and/or reduce fluid degradation by advantageously mitigating oxidation/cooking of the fluid within the cooling gallery.

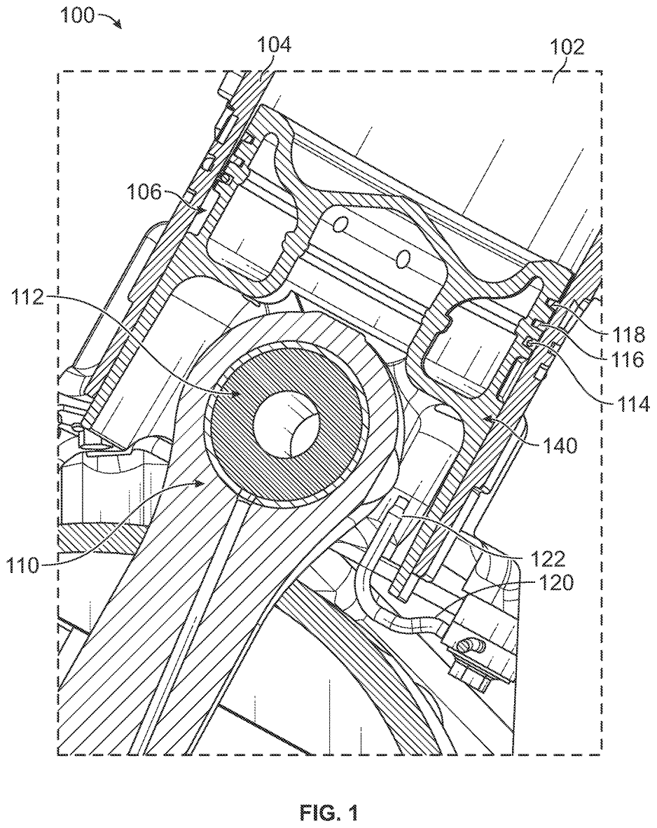

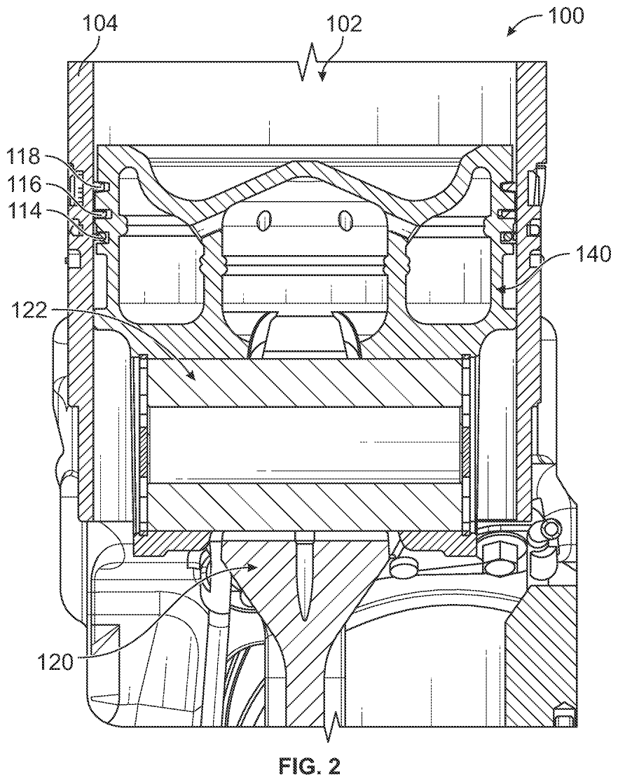

Referring to FIGS. 1 and 2, cross-sectional views of a combustion chamber assembly 100 are shown, according to an example embodiment. The combustion chamber assembly 100 may be part of an internal combustion engine, such as a spark-ignition engine or a compression-ignition engine. In some embodiments, the combustion chamber assembly 100 is configured to combust fuel, such as gasoline, diesel, propane, hydrogen, etc., to generate power. As shown, the combustion chamber assembly 100 includes a cylinder 102 and a piston 106. It should be understood that the combustion chamber assembly 100 may include more or fewer components than as shown in FIGS. 1 and 2.

A fluid injection system 120 may be positioned proximate the combustion chamber assembly 100. The fluid injection system 120 includes a nozzle 122 for supplying a fluid. The nozzle 122 may extend towards the piston 106 such that the nozzle 122 supplies the fluid to the piston 106. The fluid may include oil for use as a coolant and/or a lubricant.

The cylinder 102 includes a cylinder liner 104 that at least partially defines an internal volume. The cylinder 102 is configured to receive an air-fuel mixture within the internal volume. The air-fuel mixture may be combusted within the internal volume of the cylinder 102.

The piston 106 includes a connecting rod 110 a piston pin 112, and a piston head 140. The connecting rod 110 is configured to couple to a crankshaft of the internal combustion engine. The piston pin 112 is configured to couple the connecting rod 110 to the piston head 140. The piston head 140 is configured to at least partially define the internal volume such that, when the air-fuel mixture is combusted, the piston head 140 is translated axially within the cylinder 102 by the force of the combustion. One or more cylinder rings, shown as a first cylinder ring 114, a second cylinder ring 116, and a third cylinder ring 118 may be disposed between the piston head 140 and the cylinder liner 104. The first cylinder ring 114, the second cylinder ring 116, and the third cylinder ring 118 are expandable rings configured to form a seal between the piston head 140 and the cylinder liner 104. The piston head 140 is described in more detail herein.

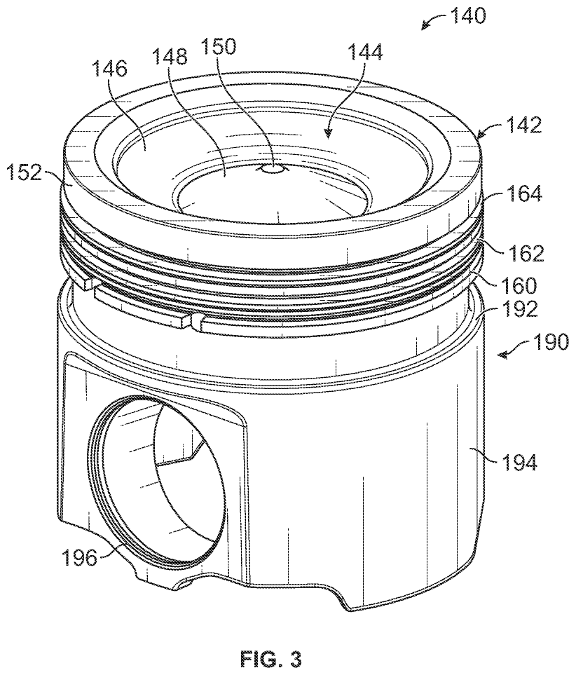

FIG. 3 is a perspective view of the piston head 140 usable in the combustion chamber assembly 100 of FIG. 1, according to an example embodiment. In an example embodiment, a piston 106 for a combustion cylinder 100 includes a piston head 140 a connecting rod 110, and a piston pin 112. The piston pin 112 couples the connecting rod 110 to the piston head 140.

The piston head 140 includes a piston head lower portion 190 and a piston head upper portion 142 coupled to the piston head lower portion 190. The piston head upper portion 142 includes an end wall 144 having an outer portion 146 and an inner portion 148, angled with respect to the outer portion 146. The piston head upper portion 142 includes an outer wall 152 extending axially away from the end wall 144 in a first direction. The piston head upper portion 142 includes an inner wall 154 extending axially away from the end wall 142 in the first direction and separated from the outer wall 152 such that an outer chamber 156 is defined between the outer wall 152 and the inner wall 154 and an inner chamber 158 is defined within the inner wall 154. The inner wall 154 defines one or more openings 168 fluidly connecting the inner chamber 158 to the outer chamber 156. An axis of each of the one or more openings 168 is substantially parallel to the inner portion 148.

The piston head upper portion 142 may be coupled to the piston head lower portion 190 by a welding operation, such as a friction welding operation.

The outer wall 152 extends around a periphery of the end wall 144 and axially away from the end wall 144 in a fist direction, towards the piston head lower portion 190. The end wall 144 includes the outer portion 146 and the inner portion 148. The outer portion 146 extends radially inward form the outer wall 152 towards the inner portion 148 and axially in a first direction, towards the piston head lower portion 190, such that the outer portion 146 defines a substantially concave shape. The inner portion 148 extends radially inwards, away from the outer portion 146, towards a center 150 of the end wall 144, and axially in a second direction, away from the piston head lower portion 190. The inner portion 148 defines a substantially convex shape such that an apex of the inner portion 148 is at the center 150. In this way, the inner portion 148 is angled with respect to the outer portion 146.

The outer wall 152 extends towards the piston head lower portion 190 such that the piston head lower portion 190 contacts the outer wall 152 when the piston head upper portion 142 is welded to the piston head lower portion 190. The piston head upper portion 142 includes one or more annular channels shown as a first annular channel 160, a second annular channel 162, and a third annular channel 164. The annular channels 160, 162, 164 extend around a periphery of the outer wall 152 in a radially outward direction. The annular channels 160, 162, 164 are configured to receive the piston rings 114, 116, 118.

In some embodiments, the piston head lower portion 190 includes a piston head body 190 that defines a first inlet port 166 and a first outlet port 167. In some embodiments the piston head lower portion 190 includes a skirt 194 extending away from the piston head body 190. The skirt 194 defines a pin port 196. The inner chamber 158 is in fluid providing communication with the pin port 196.

In some embodiments, the piston 106 includes the piston pin 112 and the connecting rod 110. The piston pin 112 couples the connecting rod 110 to the piston head 140. The piston pin 112 is received by the pin port 196.

The piston head lower portion 190 includes a piston head body 192, a skirt 194, and a pin port 196. The skirt 194 extends around a periphery of the piston head body 192 and axially away from the piston head body 192 in the first direction, away from the piston head upper portion 142. The skirt 194 at least partially defines the pin port 196. The pin port 196 is configured to receive the piston pin 112, such that, when the pin port 196 receives the piston pin 112, the connecting rod 110 is coupled to the piston head 140 by the piston pin 112.

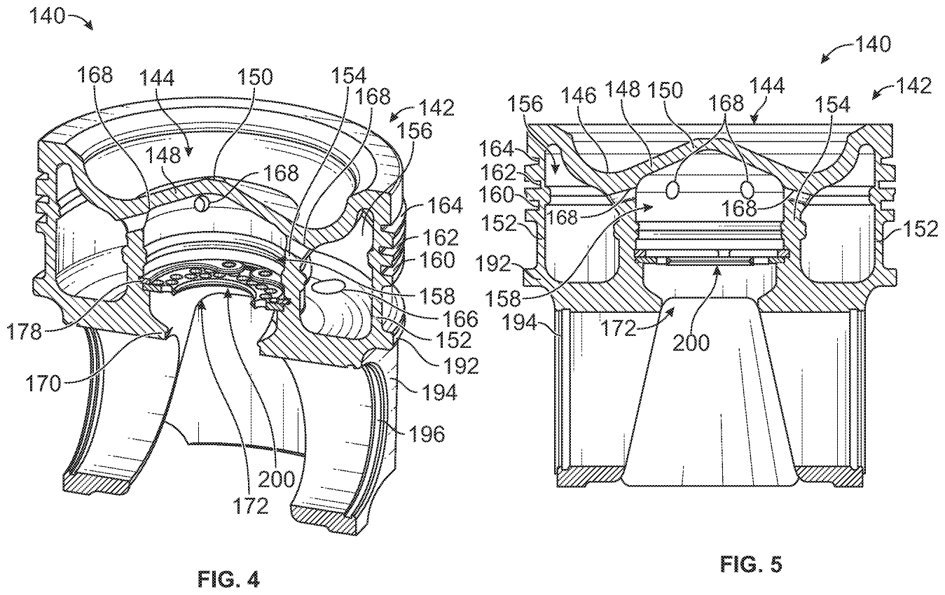

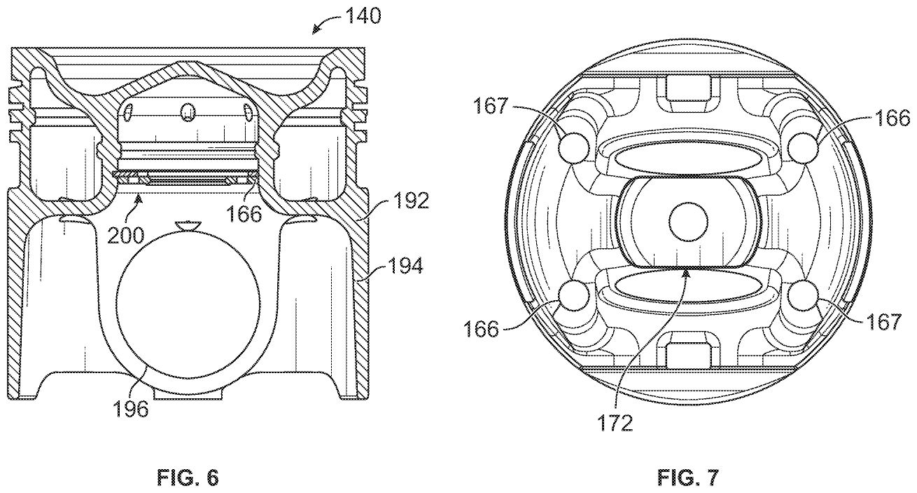

Now referring to FIGS. 4-7, various cross-sectional views of the piston head 140 of FIG. 3 are shown. In an example embodiment, a cooling gallery for a piston head 140 of a combustion cylinder 100 includes an end wall 144 including an outer portion 146 and an inner portion 148, angled with respect to the outer portion 146. The cooling gallery includes an outer wall 152 extending axially away from the end wall 144 in a first direction. The cooling gallery includes an inner wall 154 extending axially away from the end wall 144 in the first direction and separated from the outer wall 152 such that an outer chamber 156 is defined between the outer wall 142 and the inner wall 154, and an inner chamber 158 is defined within the inner wall 154. The inner wall 154 defines one or more openings 168 fluidly connecting the inner chamber 158 to the outer chamber 156. An axis of each of the one or more openings 168 is substantially parallel to the inner portion 148.

As shown, the piston head upper portion 142 includes the inner wall 154 disposed radially inward from the outer wall 152. As shown, the inner wall 154 has a non-uniform cross-section. More specifically, a width of the inner wall 154 may be non-uniform along a height of the inner wall 154. The non-uniform cross-section enables improved structural rigidity of the inner wall 154. The outer chamber 156 is defined at least partially by the outer wall 152, the outer portion 146, and the inner wall 154 and extends around a center axis of the piston head 140. The inner chamber 158 is defined at least in part by the inner wall 154 and the inner portion 148 and extends around a center axis of the piston head 140. Together, the outer chamber 156 and the inner chamber 158 define an internal volume and a surface area of the cooling gallery. The cooling gallery is configured to enable heat transfer from the piston head 140 to a fluid, such as oil. In particular embodiments, a value of a total volume of the cooling gallery is equal to a reference value that is between 251% and 350% of the inner diameter of the cylinder 102 squared. A value of a surface area of the cooling gallery is equal to a reference value that is between 20.5% and 25% of the inner diameter of the cylinder 102 squared times the compression height. The compression height is defined as a distance between a center line of the pin port 196 and a top surface of the piston head 140.

The piston head 140 includes one or more inlet ports 166 and one or more outlet ports 167. As shown in FIG. 7, the piston head body 140 includes two inlet ports 166 and two outlet ports 167. The inlet ports 166 are configured to enable a fluid to flow from the fluid injection system 120 to the outer chamber 156 such that the outer chamber is in fluid receiving communication with the fluid injection system 120 via the inlet ports 166. For example, the inlet ports 166 may receive a fluid, such as oil, from the fluid injection system 120 (e.g., via the nozzle 122) and provide the fluid to the outer chamber 156. The outlet ports 167 are configured to provide a fluid from the outer chamber 156 to a downstream device such that the outer chamber 156 is in fluid providing communication with the downstream device via the outlet ports 167. For example, the outlet ports 167 may receive a fluid from the outer chamber 156 and provide the fluid to the downstream device.

In an example embodiment, the piston head 140 includes one or more inlet ports configured receive a fluid and provide the fluid to the outer chamber. The piston head 140 includes one or more outlet ports configured to receive a fluid from the outer chamber and provide the fluid to a downstream device.

The inner wall 154 includes one or more openings 168. For example, the inner wall 154 may include between six and twelve openings 168. In some embodiments, the one or more openings 168 are equally spaced from each other. In some embodiments, the one or more openings 168 each have a diameter of between 1.5% and 7% of the inner diameter of the cylinder 102.

The openings 168 fluidly connect the outer chamber 156 and the inner chamber 158. As shown in FIGS. 4-6, the openings 168 are defined through a top end of the inner wall 154 proximate the end wall 146. The openings 168 are oblique with respect to the inner wall 156 such that a center axis of the openings 168 is substantially parallel to the inner portion 148. For example, in some embodiments the openings may be angled between 20° and 50° with respect to a horizontal axis. The openings 168 are configured to receive a fluid from the outer chamber 156 and provide the fluid to the inner chamber 158, such that the inner chamber 158 is in fluid receiving communication with the outer chamber 156 via the openings 168. When the fluid is provided to the inner chamber 158, the fluid is directed towards the inner portion 148 of the end wall 144 such that at least a portion of the fluid that flows through the openings 168 contacts the inner portion 148.

A lower portion 170 of the inner wall 154 defines a drain opening 172. The drain opening 172 enables fluid communication between the inner chamber 158 and the pin port 196, such that the pin port is in fluid receiving communication with the inner chamber 158 via the drain opening 172.

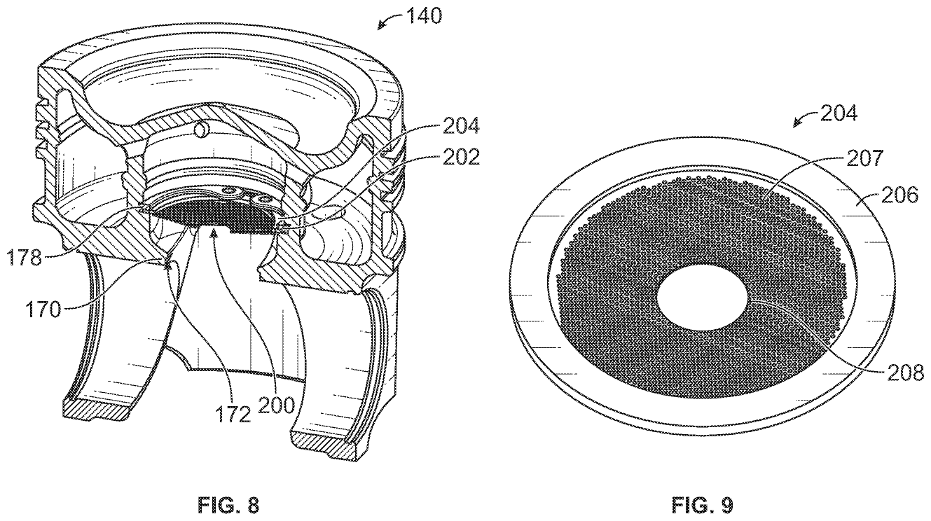

The inner wall 154 defines an inner channel 178. The inner channel 178 is configured to receive a portion of a drain plug 200. The drain plug 200 is described in more detail herein, with respect to FIGS. 8-11.

In some embodiments, during operation of the combustion chamber assembly 100, the piston head 140 translates in an axial direction within the cylinder 102. For example, the combustion of the air-fuel mixture causes the piston head 140 to translate axially towards the connecting rod 110 and the connecting rod 110 causes the piston head 140 to translate axially away from the connecting rod 110. The piston head 140 may be heated by the combustion of the air-fuel mixture in the cylinder 102.

A fluid, such as oil, is provided to the piston head 140 by the fluid injection system 120 to cool the piston head 140. The fluid may flow along a first flow path or a second flow path. For example, the fluid that flows along the first flow path enters the outer chamber 156 via the inlet ports 166 and flowing out of the outer chamber via the outlet ports 167. The fluid that flows along the second flow path enters the outer chamber 156 via the inlet ports 166, flows into the inner chamber 158 through the openings 168, and into the pin port 196 through the drain opening 172. In some embodiments, inner channel 178 is disposed upstream of the drain opening 172 such that the drain plug 200 is located upstream of the drain opening 172 and the fluid flows through the drain plug 200 before flowing through the drain opening 172.

In some embodiments, a first portion of the fluid is caused to flow along the first flow path (e.g., by gravity). A second portion of the fluid is caused to flow along the second flow path by a “sloshing” effect caused by the axial movement of the piston head 140. More specifically, after the fluid enters the outer chamber 156, at least a portion of the fluid (e.g., the second portion of the fluid) is sloshed by the axial movement of the piston head 140 such that the second portion of the fluid flows through the openings 168 and into the inner chamber 158. The second portion of the fluid may contact a lower surface of the end wall 144 such that the fluid enables heat transfer from the end wall 144 to the fluid. For example, because the center axis of the openings 168 is substantially parallel to the inner portion 148 the fluid may be directed towards the lower surface of the end wall 144. In some embodiments the second portion of the fluid is less volume and/or mass than the first portion of the fluid.

In some embodiments, as the second portion of the fluid enters the pin port 196, the second portion of the fluid also enables heat transfer from the connecting rod 110 and/or pin 112 to the fluid. In some embodiments, the fluid may coat at least a portion of the connecting rod 110 and/or the pin 112 such that the fluid lubricates the connecting rod 110 and/or the pin 112.

FIG. 8 is a perspective view of the piston head 140, according to another example embodiment. The piston head 140 shown in FIG. 8 includes a drain plug 200. The drain plug 200 includes a mesh disc 204 and a retention member shown as a circlip 202. The retention member (e.g., the circlip 202) is configured to couple the mesh disc 204 to the piston head 140 at the inner channel 178 such that the drain plug 200 is positioned upstream of the drain opening 172.

FIG. 9 is a perspective view of the mesh disc 204. As shown, the mesh disc 204 includes an annular body 206, a mesh portion 207, and an opening 208. The annular body 206 is configured to be received by the inner channel 178 such that the circlip 202 couples the mesh disc thereto. The meshed portion 207 includes a meshed material, such as steel, plastic, or other suitable material and allows the fluid to flow therethrough. The meshed portion 207 extends radially inward from the annular body 206. The meshed portion 207 defines the opening 208 at a center of the mesh disc 204. The fluid may also flow through the opening 208.

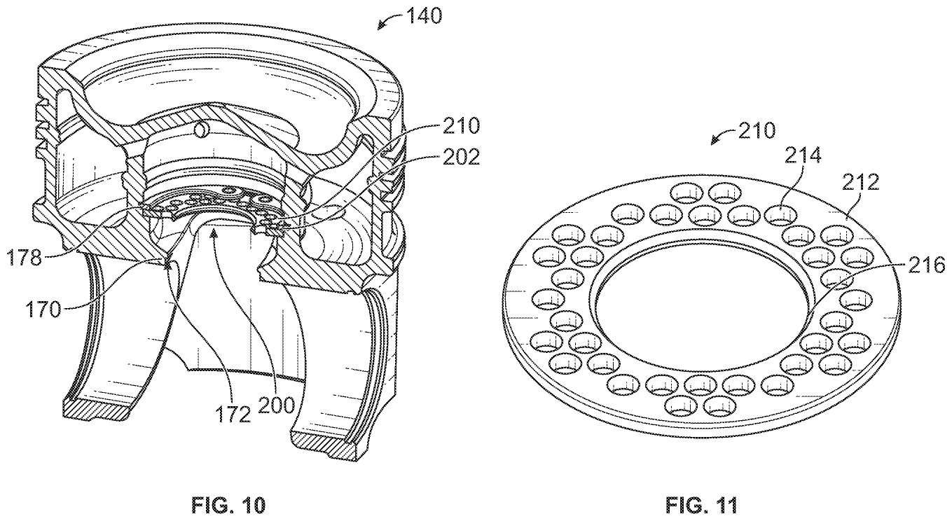

FIG. 10 is a perspective view of the piston head 140, according to another example embodiment. The piston head 140 shown in FIG. 10 includes a drain plug 200. The drain plug 200 includes a disc 210 and a retention member shown as a circlip 202. The circlip 202 is configured to couple the disc 210 to the piston head 140 at the inner channel 178 such that the drain plug 200 is positioned upstream of the drain opening 172.

FIG. 11 is a perspective view of the disc 210. The disc 210 includes an annular body 212 which includes one or more peripheral openings 214 and a central opening 216. The annular body 212 is configured to be received by the inner channel 178 such that the circlip 202 couples the disc 210 thereto. The one or more peripheral openings 214 are defined axially through the annular body 212 and allow the fluid to flow therethrough. The annular body 212 also defines the central opening 216 at a center of the disc 212. The fluid may also flow through the central opening 212.

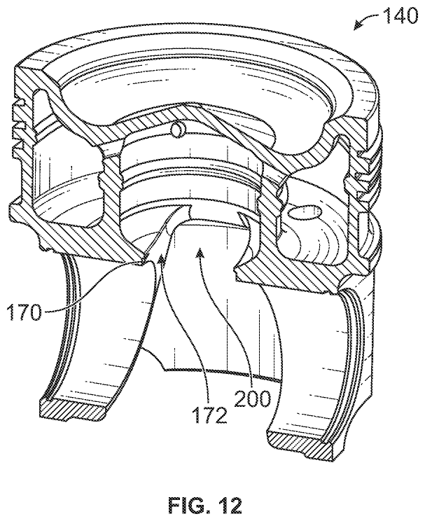

FIG. 12 is a perspective view of the piston head 140, according to another example embodiment. The piston head 140 shown in FIG. 12 does not include the drain plug 200. The inner wall 154 does not include the inner channel 178.

It should be noted that the term “example” as used herein to describe various embodiments is intended to indicate that such embodiments are possible examples, representations, and/or illustrations of possible embodiments (and such term is not intended to connote that such embodiments are necessarily extraordinary or superlative examples).

The term “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the figures. It should be noted that the orientation of various elements may differ according to other example embodiments, and that such variations are intended to be encompassed by the present disclosure.

It is important to note that the construction and arrangement of the various example embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, various parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various example embodiments without departing from the scope of the concepts presented herein

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

1. A piston head for a combustion cylinder, the piston head comprising:
a piston head lower portion; and
a piston head upper portion coupled to the piston head lower portion, the piston head upper portion comprising:
an end wall including an outer portion and an inner portion angled with respect to the outer portion;
an outer wall extending axially away from the end wall in a first direction; and
an inner wall extending axially away from the end wall in the first direction and separated from the outer wall such that an outer chamber is defined between the outer wall and the inner wall and an inner chamber is defined within the inner wall, the inner wall defining one or more openings fluidly connecting the inner chamber to the outer chamber, wherein an axis of each of the one or more openings is substantially parallel to the inner portion.

2. The piston head of claim 1, wherein the piston head lower portion includes:
a piston head body;
a skirt that extends around a periphery of the piston head body, axially away from the piston head body, and away from the piston head upper portion; and
a pin port that is at least partially defined by the skirt.

3. The piston head of claim 1, wherein the inner wall has a non-uniform cross-section.

4. The piston head of claim 1, wherein the outer chamber is further defined by the outer portion of the end wall, wherein the outer chamber extends around a center axis of the piston head.

5. The piston head of claim 1, further comprising:
one or more inlet ports configured to receive a fluid and provide the fluid to the outer chamber; and
one or more outlet ports configured to receive a fluid from the outer chamber and provide the fluid to a downstream device.

6. The piston head of claim 1, wherein the one or more openings are defined through a top end of the inner wall, proximate the end wall, and wherein the one or more openings are angled between 20° and 50° with respect to a horizontal axis.

7. The piston head of claim 1, wherein the piston head upper portion includes one or more annular channels that extend around a periphery of the outer wall in a radially outward direction.

8. A piston comprising:
the piston head of claim 1;
a connecting rod; and
a piston pin, the piston pin coupling the connecting rod to the piston head.

9. The piston of claim 8, wherein the piston head lower portion comprises a piston head body defining a first inlet port and a first outlet port.

10. The piston of claim 9, wherein the piston head lower portion comprises a skirt extending away from the piston head body, the skirt defining a pin port, wherein the inner chamber is in fluid providing communication with the pin port.

11. The piston of claim 10, wherein the piston pin is received by the pin port.

12. The piston of claim 10, wherein a lower portion of the inner wall defines a drain opening that enables fluid communication between the inner chamber and the pin port such that the pin port is in fluid receiving communication with the inner chamber via the drain opening.

13. The piston of claim 12, wherein the inner wall defines an inner channel that is configured to receive at least a portion of a drain plug, and wherein the inner channel is disposed upstream of the drain opening such that the drain plug is located upstream of the train opening.

14. The piston of claim 13, wherein the drain plug includes a mesh disc and a retention member that is configured to couple the mesh disc to the piston head at the inner channel.

15. A cooling gallery for a piston head of a combustion cylinder, the cooling gallery comprising:
an end wall including an outer portion and an inner portion, angled with respect to the outer portion;
an outer wall extending axially away from the end wall in a first direction; and
an inner wall extending axially away from the end wall in the first direction and separated from the outer wall such that an outer chamber is defined between the outer wall and the inner wall and an inner chamber is defined within the inner wall, the inner wall defining one or more openings fluidly connecting the inner chamber to the outer chamber, wherein an axis of each of the one or more openings is substantially parallel to the inner portion.

16. The cooling gallery of claim 15, wherein the inner wall defines:
a drain opening; and
an inner channel that is configured to receive a portion of a drain plug, wherein the inner channel is disposed upstream of the drain opening.

17. The cooling gallery of claim 16, wherein the drain plug comprises:
a mesh disc comprising:
an annular body configured to be received by the inner channel,
a mesh portion including a meshed material that allows the fluid to flow therethrough, and
an opening, wherein the meshed portion defines the opening at a center of the mesh disc; and
a retention member configured to couple the mesh disc to the piston head at the inner channel.

18. The cooling gallery of claim 16, wherein the drain plug comprises:
a disc comprising an annular body including one or more peripheral openings and a central opening; and
a retention member configured to couple the disc to the piston head at the inner channel.

19. The cooling gallery of claim 15, wherein a value of a total volume of the cooling gallery is equal to a reference value that is between 251% and 350% of an inner diameter of the combustion cylinder, squared.

20. The cooling gallery of claim 15, wherein a value of a surface area of the cooling gallery is equal to a reference value that is between 20.5% and 25% of an inner diameter of the combustion cylinder, squared, times a compression height of the combustion cylinder.
